(19) United States
(12) Patent Application Publication
(10) Pub. No.: US 2014/0047432 A1
(43) Pub. Date: Feb. 13, 2014

(54) IMAGE PROCESSING APPARATUS, SERVER APPARATUS, INFORMATION PROCESSING METHOD, AND PROGRAM

(71) Applicant: CANON KABUSHIKI KAISHA, Tokyo (JP)

(72) Inventor: Takumi Michishita, Kawasaki-shi (JP)

(73) Assignee: CANON KABUSHIKI KAISHA, Tokyo (JP)

(21) Appl. No.: 13/959,499

(22) Filed: Aug. 5, 2013

(30) Foreign Application Priority Data
Aug. 10, 2012 (JP) 2012-178425

(51) Int. Cl. G06F 9/445

(52) U.S. Cl. CPC G06F 8/65
USPC 717/173

(57) ABSTRACT

An image processing apparatus includes an update unit configured to, based on an update file related to update of firmware transferred from an information processing apparatus that communicates with the image processing apparatus, update the firmware, a character string creation unit configured to obtain apparatus information of the image processing apparatus and create a character string based on the obtained apparatus information, and an instruction unit configured to, in a case where the update unit succeeds with the update of the firmware, instruct the information processing apparatus to access a server apparatus that communicates with the information processing apparatus using location information of the server apparatus to which the character string created by the character string creation unit is attached.

### BACKGROUND

1. Field of the Disclosure

Aspects of the present invention generally relate to an image processing apparatus, a server apparatus, information processing method, and a program.

2. Description of the Related Art

With the rapid improvement of functions of image processing apparatuses, firmware of the image processing apparatuses are required to be updated quickly and efficiently (at low cost). Conventionally, firmware of the image processing apparatus is manually updated by a service person who visits a customer site, in a case where the firmware needs to be updated due to version upgrade, a failure, and the like. Therefore, the firmware cannot be updated quickly and also needs time and cost for dispatch of a service person who performs the update of the firmware.

Thus, in recent years, a technique has been discussed which configures an image processing apparatus to store firmware in a rewritable storage device such as a flash memory and update the firmware by transmitting the firmware via the Internet.

Japanese Patent Application Laid-Open No. 2006-72791 discusses a technique related to a portable electronic apparatus which can communicate with an update server via a communication line. The portable electronic apparatus discussed in Japanese Patent Application Laid-Open No. 2006-72761 automatically accesses the update server at a predetermined timing to request update of the firmware, and receives the firmware transmitted from the update server in response to the request, thus the update of the firmware is performed. The portable electronic apparatus discussed in Japanese Patent Application Laid-Open No. 2006-72761 stops receiving the firmware when voltage of a battery power supply is lower than a predetermined value.

As described above, a method for automatically updating the firmware by downloading it from the server on a personal computer (PC) has became a recent mainstream instead of a method for manually updating the firmware by a service person.

In addition, a technique for connecting to the image processing apparatus via a network from the PC and enabling a user to perform operations from a remote client PC by displaying user interfaces (UIs) (e.g., a system status, a print job queue, and various parameter settings) on a WEB browser has been common.

Japanese Patent Application Laid-Open No. 11-296468 discusses an image processing apparatus which is remotely controlled by an external computer or the like via a network using data and a script for controlling an apparatus installed on a WEB server.

For example, in a case where problems that damage user's interests, such as leakage of personal information and troubles with charging are to be solved by correction of the firmware, the update of the firmware needs to be immediately performed on apparatuses in the market.

In a case where a method for automatically updating the firmware by downloading it from the server as discussed in Japanese Patent Application Laid-Open No. 2006-72761 is used, the completion of the update processing can be directly notified to the server, so that to identify and manage the apparatus in which the processing is completed is easy. However, the method discussed in Japanese Patent Application Laid-Open No. 2006-72761 is based on the premise that a target image processing apparatus is connected to an external network, thus this method cannot be applied depending on a network environment.

As described above, there is a case that an image processing apparatus cannot be directly connected to the external network depending on the usage environment of the image processing apparatus. In such a case, it is assumed that the firmware of the image processing apparatus is updated by performing operations using the WEB browser from a PC connected to an in-house network as in the technique discussed in Japanese Patent Application Laid-Open No. 11-296468. At that time, the fact that the updated file is downloaded from the server to the PC can be managed, however, whether the firmware of the image processing apparatus has been properly updated cannot be managed. Accordingly, omission of update may occur.

### SUMMARY

According to an aspect of the present invention, an image processing apparatus includes a memory and a processor in communication with the memory, the processor configured to control an update unit configured to, based on an update file related to update of firmware transferred from an information processing apparatus that communicates with the image processing apparatus, update the firmware, a character string creation unit configured to obtain apparatus information of the image processing apparatus and create a character string based on the obtained apparatus information, and an instruction unit configured to, in a case where the update unit succeeds with the update of the firmware, instruct the information processing apparatus to access a server apparatus using a URL, to which the character string is attached.

Further features of the present disclosure will become apparent from the following description of exemplary embodiments with reference to the attached drawings.

### BRIEF DESCRIPTION OF THE DRAWINGS

FIG. 1A illustrates an example of a hardware configuration of an image processing apparatus. FIG. 1B illustrates an example of a hardware configuration of a firmware server.

FIG. 2 illustrates an example of a software configuration of an image processing apparatus.

FIG. 3 illustrates an example of a network configuration including an image processing apparatus, a PC, and a firmware server.

FIG. 4 is a flow chart illustrating an example of information processing performed by a WEB browser operating on a PC.

FIG. 5 is a flow chart illustrating an example of information processing performed by an image processing apparatus.

FIG. 6 is a sequence chart illustrating an example of information processing performed by a firmware server, a WEB browser, and an image processing apparatus.

FIG. 7 is an example of an execution result screen to be displayed on a WEB browser by processing in step S405 in FIG. 4.

FIG. 8 is an example of a version upgrade result screen to be displayed on a WEB browser by processing in step S614 in FIG. 6.

### DESCRIPTION OF THE EMBODIMENTS

Exemplary embodiments, features, and aspects of the present invention will be described in detail below with reference to the drawings.

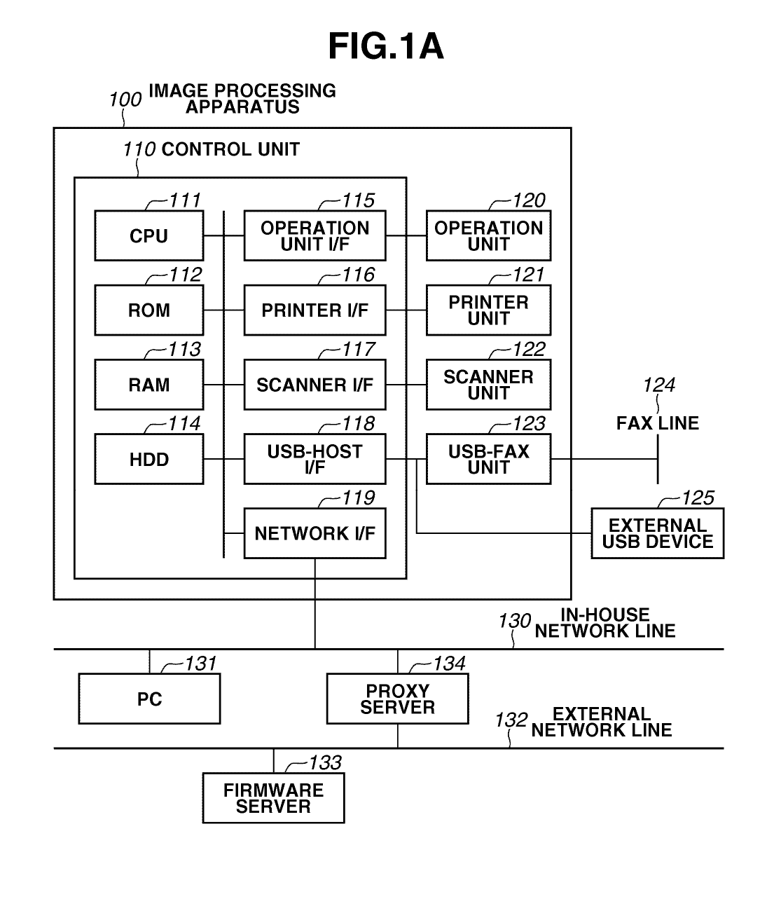

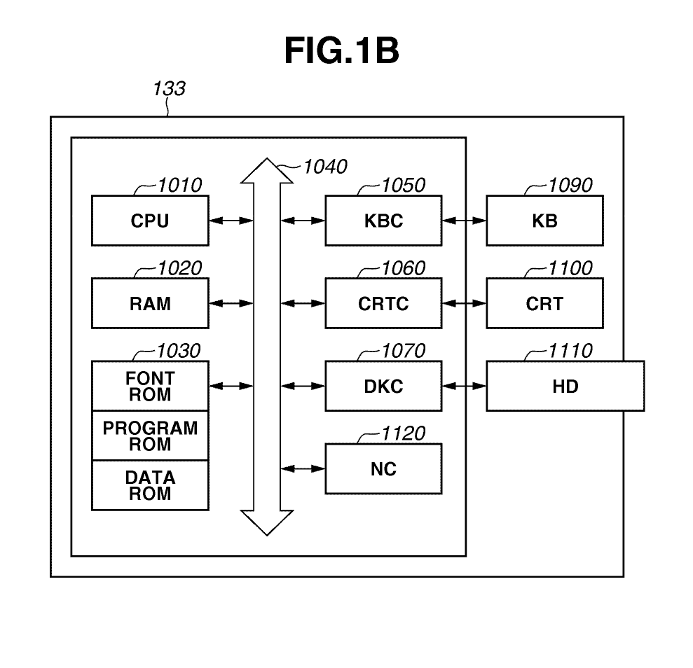

FIG. 1A illustrates an example of a hardware configuration of an image processing apparatus 100.

In FIG. 1A, a control unit 110 is configured to control entire image processing apparatus 100. The control unit 110 includes the following units as a configuration to control the image processing apparatus 100.

A central processing unit (CPU) 111 reads a program for the control unit 110 which is stored in a read-only memory (ROM) 112 to a random access memory (RAM) 113 and executes the program. The ROM 112 also stores device information pieces such as a serial identification (ID) for uniquely identifying the image processing apparatus 100, device configuration information, and a firmware version.

A hard disk drive (HDD) 114 stores print data received from a personal computer (PC) 131 via a network interface (I/F) 119. Programs to be executed by the CPU 111 includes a print application program. The CPU 111 executes processing based on the print application program, and thus the print data stored in the HDD 114 is converted into image data which is printable by a printer unit 121. The HDD 114 further stored image data printable by the printer unit 121. Programs executed by the CPU 111 include a scanning application program. The CPU 111 executes processing based on the scanning application program, and thus image data is read by a scanner unit 122, and also the read image data is transferred to the HDD 114. The HDD 114 also stores the read image data.

An operation unit I/F 115 is an interface for transmitting an instruction input via an operation unit 120 by a user of the image processing apparatus 100 to the CPU 111. Further, the operation unit I/F 115 receives a processing content for changing a content to be displayed on the operation unit 120 from the CPU 111 and transmits the processing content to the operation unit 120. The operation unit 120 may include a liquid crystal display unit having a touch panel function and a keyboard for receiving a user instruction.

A printer I/F 116 is an interface for connecting the control unit 110 and the printer unit 121. The printer unit 121 performs printing on a recording medium based on the image data transferred from the HDD 114 via the printer I/F 116.

A scanner I/F 117 is an interface for connecting the control unit 110 and the scanner unit 122. The scanner unit 122 reads an image on a document as image data using a line sensor configured with a charged coupled device (CCD) or the like. The scanner unit 122 then transfers the read image data to the HDD 114 via the scanner I/F 117. The image data which is transferred to and stored in the HDD 114 can be printed by the above-described printer unit 121. The image data read by the scanner unit 122 is printed by the printer unit 121, and thus the image data can be subjected to copying processing.

A Universal Serial Bus (USB)-Host I/F 118 is an interface for connecting the control unit 110 and a USB-FAX unit 123. The USB-FAX unit 123 transmits a facsimile using a FAX line 124 based on the image data transferred from the HDD 114 via the USB-Host I/F 118. In addition, the USB-FAX unit 123 generates image data based on data received via the FAX line 124 and transfers the generated image data to the HDD 114 via the USB-Host I/F 118. As described above, the image data stored in the HDD 114 can be printed on a sheet by the printer unit 121. The USB-Host I/F 118 can also be connected to an external USB device 125. Examples of the external USB device 125 include a USB memory, a USB keyboard, and the like.

The network I/F 119 connects the control unit 110 to an in-house network line 130, and communicates with the PC 131 on the in-house network line 130. According to the present exemplary embodiment, it is assumed that the image processing apparatus 100 is not directly connected to an external network line 132. The in-house network line 130 is an example of an internal network. The external network line 132 is an example of an external network.

The PC 131 is connected to the image processing apparatus 100 by the in-house network line 130, and can transmit print data and operate devices based on a user's operation on a screen via a WEB browser with respect to the image processing apparatus 100. Further, the PC 131 is connected to a firmware server 133 via the external network line 132, and can download an update file necessary for updating the firmware of the image processing apparatus 100. Means for downloading the update file includes a hypertext transfer protocol (HTTP), a file transfer protocol (FTP), and the like, however, protocols to be used are not limited in the present exemplary embodiment.

The firmware server 133 exists on the Internet.

The PC 131 is connected only to the in-house network line 130, as similar to the image processing apparatus 100, and the in-house network line 130 and the external network line 132 are connected to each other via a proxy server 134. In FIG. 1A, the image processing apparatus 100 cannot access the external network line 132 directly, and only the PC 131 which has a connection setting to the proxy server 134 can access the external network line 132. There may be a case that the PC 131 is connected to both of the in-house network line 130 and the external network line 132 without via the proxy server 134. In such a case, the following exemplary embodiment can be applied.

The CPU 111 of the control unit 110 executes processing based on programs stored in the ROM 112, the HDD 114, or the like, and thus a below-described software configuration and processing according to below-described flow charts of the image processing apparatus 100 can be realized.

FIG. 1B illustrates an example of a hardware configuration of the firmware server 133.

A CPU 1010 executes a program, such as an operating system or a general application loaded from a ROM 1030 or a hard disk (HD) 1110 to a RAM 1020, and realize functions or the like provided by the firmware server 133.

The RAM 1020 functions as a main memory, a work area, and the like of the CPU 1010. A keyboard controller (KBC) 1050 controls key inputs from a keyboard (KB) 1090 and a pointing device (not illustrated). A cathode ray tube controller (CRTC) 1060 controls display on a CRT display 1100. A disk controller (DKC) 1070 controls accesses between the HD 1110 or a flexible disk (FD) which store a boot program, various types of application, font data, a user file, and the like A network controller (NC) 1120 is connected to the network, and executes communication control processing between other devices connected to the network.

The PC 131 and the proxy server 134 include hardware configurations similar to the hardware configuration of the firmware server 133 as illustrated in FIG. 1B. The CPUs of the respective apparatuses execute processing based on the programs stored in the ROMs or the HDs of the respective apparatuses, so that functions of the respective apparatuses can be realized. For example, the CPU of the PC 131 executes processing based on the program of the WEB browser stored in the ROM or the HD of the PC 131, so that functions of a WEB browser 220 and processing in a flow chart performed by the WEB browser 220, which are described below, are realized. For simplifying the description below, processing may be described to be performed by the WEB browser 220 instead of by the CPU of the PC 131 in some cases.

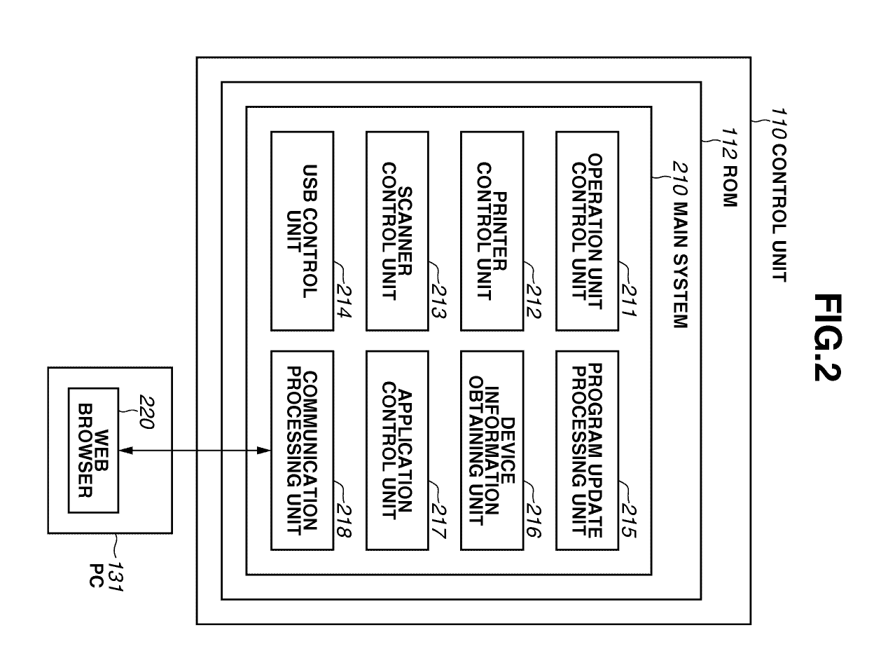

FIG. 2 illustrates an example of a software configuration of the image processing apparatus 100.

A main system 210 includes modules for realizing various functions of the image processing apparatus 100 according to the present exemplary embodiment.

An operation unit control unit 211 controls the operation unit 120 via the operation unit I/F 115.

Similarly, a printer control unit 212 controls the printer unit 121 via the printer I/F 116. A scanner control unit 213 controls the scanner unit 122 via the scanner I/F 117. Similarly, a USB control unit 214 controls USB devices connected thereto via the USB-Host I/F 118.

A program update processing unit 215 performs update processing on programs related to the above-described control units 211 to 214 in a case where an instruction to execute update of the firmware is received from a user via the WEB browser 220.

A device information obtaining unit 216 obtains device information pieces (serial ID, device configuration information, a firmware version, and the like) which the image processing apparatus 100 stores in the ROM 112. According to the present exemplary embodiment, the serial ID obtained by the device information obtaining unit 216 is used as information for identifying a device which is described below as an example. The serial ID is an example of apparatus information.

An application control unit 217 is a module group for realizing the various functions of the image processing apparatus 100 while the application control unit 217 does not directly control external devices. The application control unit 217 includes the Hypertext Transfer Protocol Daemon (HTTPD). The HTTPD is used to transfer contents stored in a server, to activate Common Gateway Interface (CGI) scripts, and so on in response to a user's request.

A communication processing unit 218 communicates with the PC 131 to transfer an update file and update information necessary for the update of the firmware.

The WEB browser 220 is activated on the PC 131 and communicates with application control unit 217 via the communication processing unit 218 according to the HTTP protocol. More specifically, the communication processing unit 218 requests the application control unit 217 to provide an operation screen to be displayed on the WEB browser 220. In addition, the communication processing unit 218 notifies the application control unit 217 of a user's instruction input via the operation screen displayed on the WEB browser 220.

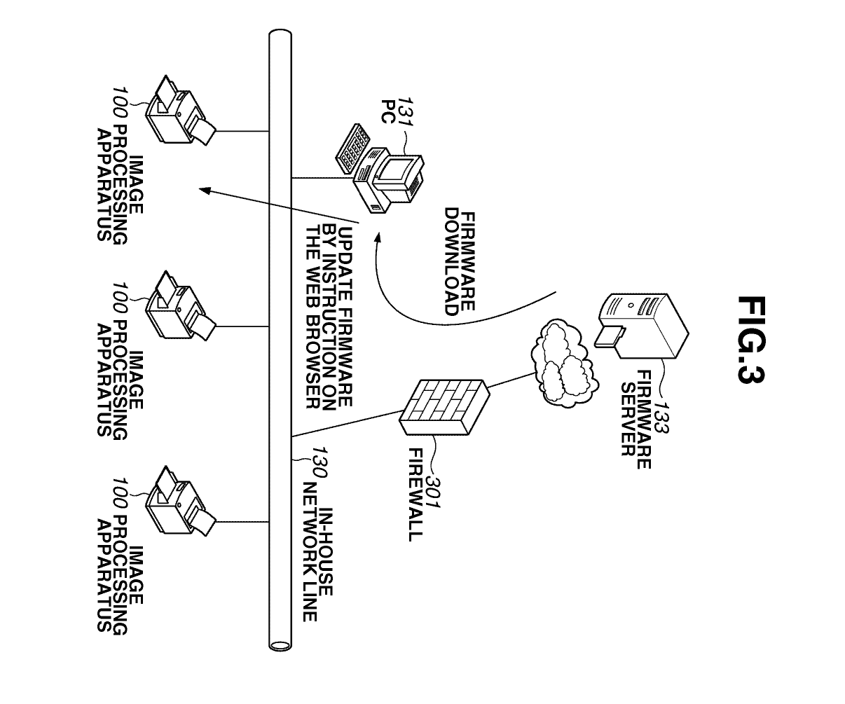

FIG. 3 illustrates an example of a network configuration including the image processing apparatus 100, the PC 131, and the firmware server 133.

The image processing apparatus 100 is communicably connected to the PC 131 via the in-house network line 130. As illustrated in FIG. 3, the network configuration may include a plurality of the image processing apparatuses 100 to be connected to the PC 131. The PC 131 is connected to the Internet via the in-house network line 130 over a firewall 301.

The firmware server 133 exists on the Internet and delivers an update file necessary for updating the firmware as needed.

In a general corporate network configuration, the PC 131 and the image processing apparatus 100 are connected to the in-house network line 130, and the firewall 301 is constructed between the in-house network line 130 and the Internet as security measures as illustrated in FIG. 3.

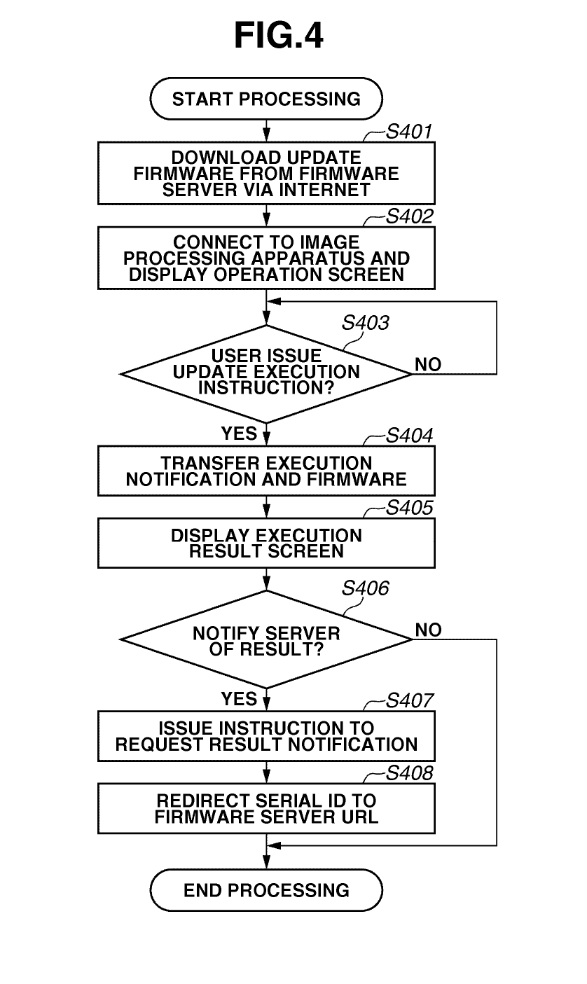

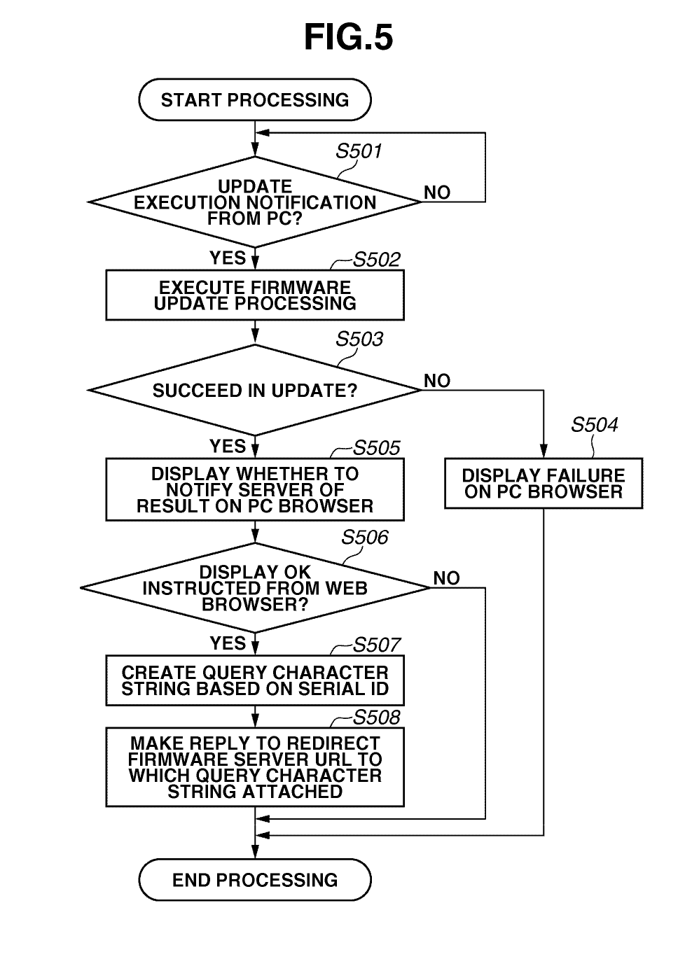

Next, the firmware update processing according to the present exemplary embodiment is described with reference to FIGS. 4 and 5.

FIG. 4 is a flow chart illustrating an example of information processing performed by the WEB browser 220 operating on the PC 131.

An outline of the processing performed on the WEB browser 220 side is described below.

In step S401, the WEB browser 220 downloads an update file necessary for updating the firmware from the firmware server 133 via the Internet according to a user's instruction.

Next, in step S402, the WEB browser 220 connects to the image processing apparatus 100 via the communication processing unit 218, and displays an operation screen in response to a reply from the application control unit 217. More specifically, the WEB browser 220 prompts a user to input an Internet protocol (IP) address or the like of the image processing apparatus 100 on the browser. When the IP address is input, the WEB browser 220 requests the image processing apparatus 100 to provide a screen to be displayed, and displays the screen obtained from the image processing apparatus 100.

Then, in step S403, the WEB browser 220 waits for an input of an execution instruction to update the firmware from the user. When the user selects execution of update on the screen of the WEB browser 220 and specifies the update file downloaded in step S401, the execution of the update processing is instructed to the image processing apparatus 100.

When the execution of the update processing is instructed by the user (YES in step S403), then in step S404, the WEB browser 220 notifies the image processing apparatus 100 of execution of the firmware update and transfers the update file related to the firmware update.

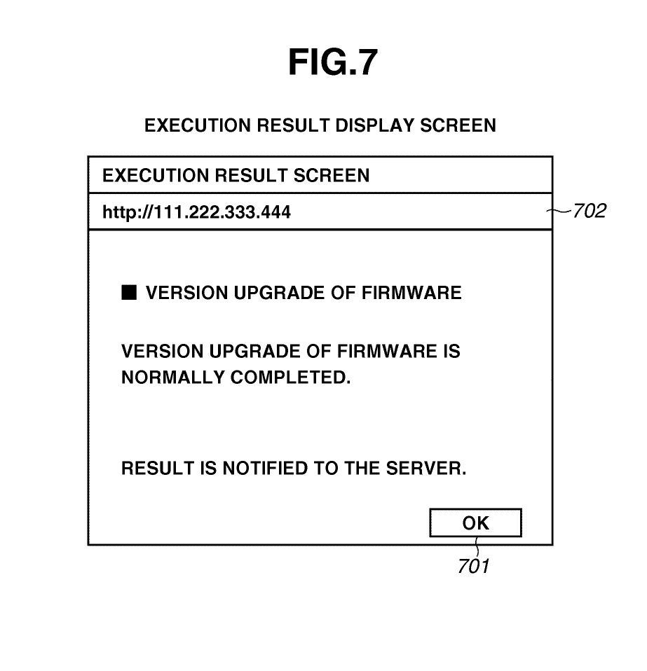

In step S405, the WEB browser 220 receives a screen for an execution result of the update processing (i.e., execution result screen) from the image processing apparatus 100 and display the screen on the browser. In a case where the update is normally completed, the WEB browser 220 displays the execution result screen as in FIG. 7 which is described below. The execution result screen includes an OK button 701 for allowing the user to select whether to notify the firmware server 133 of the result.

In step S406, if the OK button 701 is selected by the user on the screen illustrated in FIG. 7 (YES in step S406), the WEB browser 220 advances the processing to step S407. In step S407, the WEB browser 220 issues an instruction of permission of result notification (i.e., a result notification request) to the image processing apparatus 100. The image processing apparatus 100 creates a query character string by below-described processing, and returns a reply status for redirecting to a uniform resource locator (URL) of the firmware server 133 to the WEB browser 220. Here, the URL is an example of location information for indicating a location of an information resource (i.e., a document or an image) or the like existing on the Internet.

In step S408, the WEB browser 220 accesses the URL of the firmware server 133 using the serial ID of the image processing apparatus 100 to which the query character string is attached in accordance with the reply status for redirecting.

If, in step S406, the OK button 701 is not selected and the result notification is not instructed (NO in step S406), the WEB browser 220 terminates the processing illustrated in FIG. 4 without doing anything.

The WEB browser 220 may automatically advance the processing to steps S407 and S408 to access the firmware server 133 without displaying the screen for confirming the notification in step S406.

FIG. 5 is a flow chart illustrating an example of information processing performed by the image processing apparatus 100.

An outline of the processing performed on the image processing apparatus 100 side is described below.

In step S501, the CPU 111 receives execution notification based on the execution instruction to update the firmware and the update file related to the firmware update from the WEB browser 220.

Then, in step S502, the CPU 111 executes the update processing of the firmware. More specifically, the program update processing unit 215 performs the update processing on programs related to the operation unit control unit 211, the printer control unit 212, the scanner control unit 213, and the USB control unit 214, which are recorded in the ROM 112 based on the update file.

Next in step S503, the program update processing unit 215 determines whether the update processing in step S502 has succeeded. In step S503, if it is determined that the update processing has failed (NO in step S503), the program update processing unit 215 advances the processing to step S504.

In step S504, the application control unit 217 notifies the WEB browser 220 of the PC 131 to display a screen indicating that the processing is not normally completed. Since the user can understand that the firmware update processing has failed for some reason from the screen, the user can perform retry processing and/or make an inquiry to a service representative.

On the other hand, in step S503, if it is determined that the update processing has been normally completed (YES in step S503), the program update processing unit 215 advances the processing to step S505.

In step S505, the application control unit 217 returns a reply to the WEB browser 220 to display a screen indicating that the firmware update processing has succeeded. As described with reference to FIG. 4, the screen illustrated in FIG. 7, which is described below, is an example of a screen displayed on the WEB browser 220 in step S505.

In step S506, if the application control unit 217 receives the result notification request (the permission of result notification) transmitted in above-described step S407 (YES in step S506), the application control unit 217 advances the processing in step S507.

In step S507, the device information obtaining unit 216 obtains a value specific to the device (here, the serial ID). Based on the obtained serial ID or the like, the application control unit 217 creates the query character string to be notified to the firmware server 133 (character string creation). More specifically, based on the serial ID of the image processing apparatus 100 and firmware versions (version information) before and after the firmware update, the application control unit 217 creates the query character string including these information pieces.

Then, in step S508, the application control unit 217 attaches the query character string created in step S507 to the URL of the firmware server 133, and returns a reply status to the WEB browser 220 to cause the WEB browser 220 to redirect to the URL. According to the reply status, the WEB browser 220 performs the redirecting access described in step S408. Therefore, if the image processing apparatus 100 cannot directly access the firmware server 133, identification information about the device which has succeeded in the update can be notified to the firmware server 133.

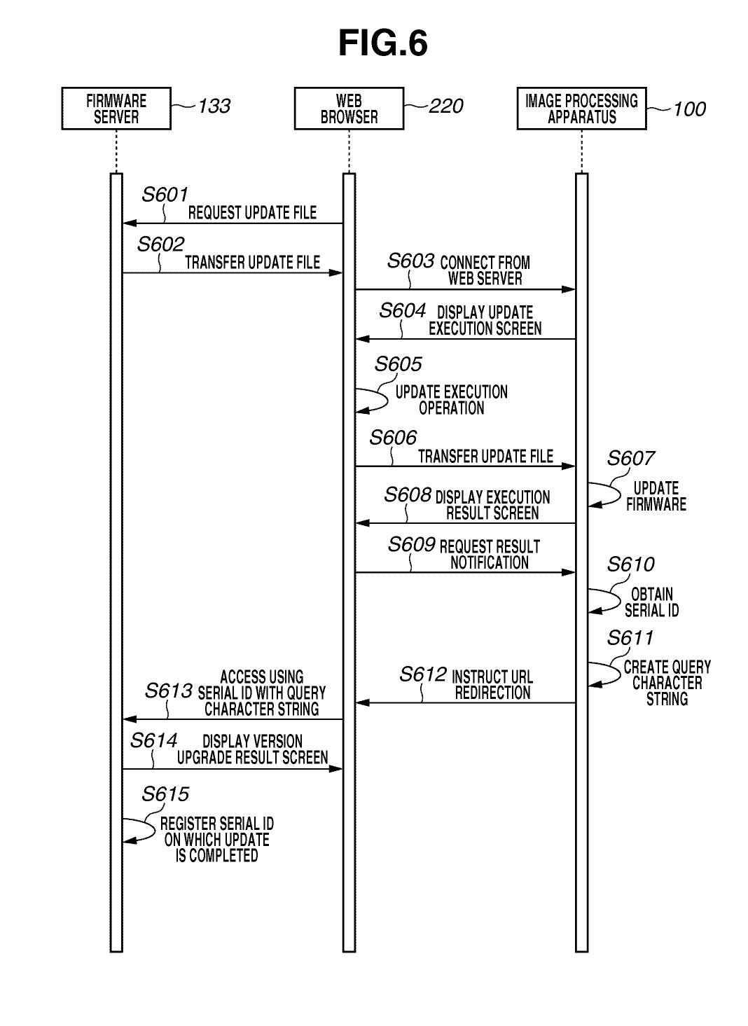

FIG. 6 is a sequence chart illustrating an example of information processing performed by the firmware server 133, the WEB browser 220, and the image processing apparatus 100.

HTTP has unique features that a server returns a reply status to a request from a client. In FIG. 6, the WEB browser 220 is positioned as a client, and the image processing apparatus 100 and the firmware server 133 are positioned as servers. A request is transmitted from the WEB browser 220 serving as the client, and a reply is returned from the image processing apparatus 100 and the firmware server 133.

First, in step S601, the WEB browser 220 sends the firmware server 133 an obtaining request to provide the update file necessary for updating the firmware.

In step S602, the firmware server 133 transfers the update file in response to the obtaining request.

Next, in step S603, the WEB browser 220 sends a connection request to the image processing apparatus 100.

In step S604, the image processing apparatus 100 returns display of the update execution screen to the WEB browser as a reply to the connection request.

In step S605, a user inputs an instruction to execute the update on the update execution screen on the WEB browser 220, and the WEB browser 220 receives the instruction.

In step S606, the WEB browser 220 transfers the update file as a request to the image processing apparatus 100.

In step S607, the image processing apparatus 100 performs firmware update processing with respect to the program stored in the ROM 112.

In step S608, the image processing apparatus 100 returns display of the execution result screen (i.e., an update result screen) to the WEB browser 220 as a reply.

In step S609, when the OK button 701 is selected on the execution result screen in FIG. 7, as described above, the WEB browser 220 instructs the image processing apparatus 100 to notify the result (i.e., a result notification request).

Upon receiving the request, in step S610, the image processing apparatus 100 obtains the serial ID.

In step S611, the image processing apparatus 100 creates the query character string based on the obtained serial ID or the like.

Then in step S612, the image processing apparatus 100 returns a reply to the WEB browser 220 and causes the WEB browser 220 to redirect to and access the URL including the query character string.

In step S613, the WEB browser 220 accesses (sends a request) the firmware server 133 using the received URL.

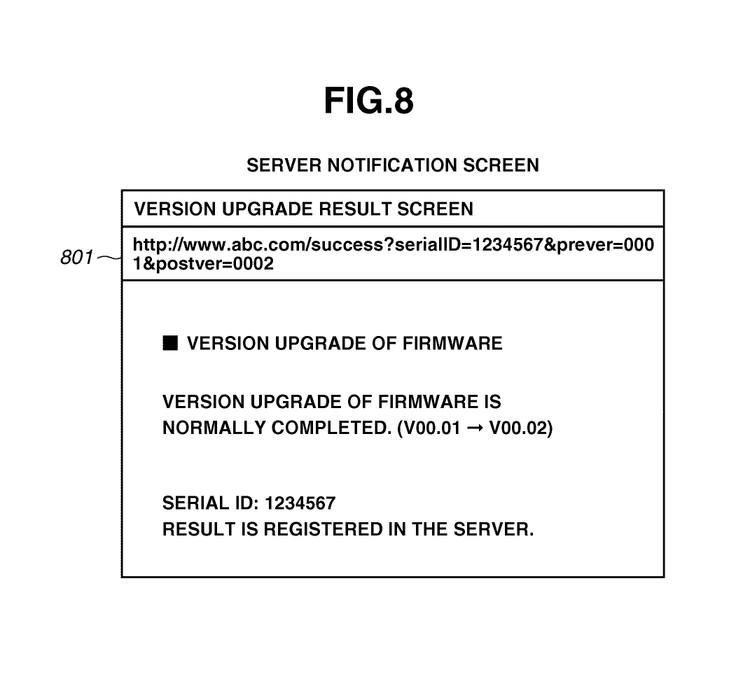

In step S614, the firmware server 133 returns a reply status to the WEB browser 220 to display a version upgrade result screen as illustrated in FIG. 8, which is described below.

In step S615, the firmware server 133 also analyzes the query character string and registers the serial ID of which update processing has been normally completed.

Examples of screens to be displayed on the WEB browser 220 according to the processing described above with reference to FIGS. 4 to 6 are illustrated in FIGS. 7 and 8.

FIG. 7 illustrates an example of the execution result screen displayed on the WEB browser 220 by the processing in step S405 in FIG. 4. As illustrated in FIG. 7, the execution result screen includes the OK button 701. The execution result screen also includes an address bar 702, and the IP address of the image processing apparatus 100 (i.e., 111.222.333.444) is input in the address bar 702. The screen processed by the application control unit 217 is displayed on the WEB browser 220.

FIG. 8 illustrates an example of the version upgrade result screen displayed on the WEB browser 220 as a result of the processing in step S614 in FIG. 6.

As illustrated in FIG. 8, the version upgrade result screen includes an address bar 801. The address bar 801 in FIG. 8 indicates an example in which the serial ID of the query character string (1234567), a firmware version (001) before the update, and a firmware version (002) after the update are included.

The firmware server 133 can specify and manage the image processing apparatus 100 in which the firmware update is completed based on the character string in the address bar 801. As for information pieces to be included in the query character string, in addition to the serial ID indicated in FIG. 8, configuration information and various setting values of the image processing apparatus 100 may be included, and items can be combined with each other as necessary.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above-described exemplary embodiments, in software update in the image processing apparatus 100, if the image processing apparatus 100 is in the environment from which the image processing apparatus 100 cannot directly access the Internet, a result of a version upgrade can be notified to the firmware server 133. Accordingly, the image processing apparatus 100 can be specified in which an important version upgrade is not implemented. Further, the above-described exemplary embodiments enable prompt dispatch of a service person to a user of the image processing apparatus 100 in which version upgrade is not appropriately performed.

Accordingly, the image processing apparatus 100 can avoid omission of the firmware update.

While the present disclosure has been described with reference to exemplary embodiments, it is to be understood that these embodiments are not limiting. The scope of the following claims is to be accorded the broadest interpretation so as to encompass all such modifications and equivalent structures and function.

For example, according to the above-described exemplary embodiments, the image processing apparatus 100 as described as an example, however, these embodiments are not limiting and other apparatuses, such as an information processing apparatus such as a PC are applicable.

According to the present disclosure, firmware of an image processing apparatus can be updated without omission.

This application claims the benefit of Japanese Patent Application No. 2012-178425 filed Aug. 10, 2012, which is hereby incorporated by reference herein in its entirety.

What is claimed is:

1. An image processing apparatus comprising:
a memory; and
a processor in communication with the memory, the processor configured to control:
an update unit configured to, based on an update file related to update of firmware transferred from an information processing apparatus that communicates with the image processing apparatus, update the firmware;
a character string creation unit configured to obtain apparatus information of the image processing apparatus and create a character string based on the obtained apparatus information; and
an instruction unit configured to, in a case where the update unit succeeds with the update of the firmware, instruct the information processing apparatus to access a server apparatus using a URL, to which the character string is attached.

2. The image processing apparatus according to claim 1, wherein the character string creation unit is configured to obtain identification information for uniquely identifying the image processing apparatus and create the character string based on the obtained identification information.

3. The image processing apparatus according to claim 1 wherein the processor is further configured to control:
a display unit configured to cause a display apparatus of the information processing apparatus to display a screen enabling an operator to confirm whether to notify the server apparatus of a result of the update.

4. A server apparatus comprising:
a memory; and
a processor in communication with the memory, the processor configured to control:
a transfer unit configured to, based on a request from an information processing apparatus that communicates with the server apparatus for an update file related to update of firmware of an image processing apparatus that communicates with the information processing apparatus, transfer the update file to the information processing apparatus;
a display unit configured to cause a display apparatus of the information processing apparatus to display a firmware update result screen in a case where the information processing apparatus accesses the server apparatus using a URL of the server apparatus to which a character string created based on apparatus information of the image processing apparatus is attached; and
a registration unit configured to analyze the character string and register apparatus information of an image processing apparatus in which update of firmware is completed.

5. A method for information processing executed by an image processing apparatus, the method comprising:
updating, based on an update file related to update of firmware transferred from an information processing apparatus that communicates with the image processing apparatus, the firmware;
obtaining apparatus information of the image processing apparatus and creating a character string based on the obtained apparatus information; and
instructing, in a case where the firmware is successfully updated, the information processing apparatus to access a server apparatus using a URL, to which the character string is attached.

6. A method for information processing executed by a server apparatus, the method comprising:
transferring, based on a request from an information processing apparatus that communicates with the server apparatus for an update file related to update of firmware of an image processing apparatus that communicates with the information processing apparatus, the update file to the information processing apparatus;
causing a display apparatus of the information processing apparatus to display a firmware update result screen in a case where the information processing apparatus accesses a URL of the server apparatus to which a character string created based on apparatus information of the image processing apparatus is attached; and
analyzing the character string and registering apparatus information of an image processing apparatus in which update of firmware is completed.

7. A computer-readable storage medium storing a program for causing a computer to perform:
updating, based on an update file related to update of firmware transferred from an information processing apparatus that communicates with the image processing apparatus, the firmware;
obtaining apparatus information of the computer and creating a character string based on the obtained apparatus information; and
instructing, in a case where the firmware is successfully updated, the information processing apparatus to access a server apparatus using a URL, to which the character string is attached.

8. A computer-readable storage medium storing a program for causing a computer to perform:
transferring, based on a request from an information processing apparatus that communicates with the server apparatus for an update file related to update of firmware of an image processing apparatus that communicates with the information processing apparatus, the update file to the information processing apparatus;
causing a display apparatus of the information processing apparatus to display a firmware update result screen in a case where the information processing apparatus accesses the computer using location information of the computer to which a character string created based on apparatus information of the image processing apparatus is attached; and
analyzing the character string and registering apparatus information of an image processing apparatus in which update of firmware is completed.
